(19) United States
(12) Patent Application Publication
(10) Pub. No.: US 2008/0150964 A1
(43) Pub. Date: Jun. 26, 2008

(54) METHOD AND APPARATUS FOR DISPLAYING CONTENT

(75) Inventor: Kyung-sun Cho, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/962,908

(22) Filed: Dec. 21, 2007

(30) Foreign Application Priority Data
Dec. 21, 2006 (KR) 10-2006-0132021

(51) Int. Cl. G09G 5/00

(52) U.S. Cl. 345/629

(57) ABSTRACT

Provided are a method and apparatus for displaying content. The method includes receiving changed scene information if scene information containing position information indicating the time at which objects constituting the content are displayed and positions of the objects to be displayed is changed, receiving objects for constituting the content based on the changed scene information and determining whether objects overlapping each other exist among the received objects, and displaying the content after selectively changing positions of the objects according to the determination result.

### CROSS-REFERENCE TO RELATED PATENT APPLICATION

This application claims priority from Korean Patent Application No. 10-2006-0132021, filed on Dec. 21, 2006, in the Korean Intellectual Property Office, the disclosure of which is incorporated herein by reference in its entirety.

### BACKGROUND OF THE INVENTION

1. Field of the Invention

Methods and apparatuses consistent with the present invention relate to displaying content, and more particularly, to displaying content, whereby the content is displayed so as to prevent objects of the content from overlapping.

2. Description of the Related Art

Content is constituted of various objects such as audio, video, an image, and text. Image compression technology for displaying content constituted of various objects, such as Moving Picture Experts Group Compression Standard Version 4 (MPEG-4) Binary Format for Scenes (BIFS), has been developed.

MPEG-4 BIFS is a binary format representation engine framework for implementing a 2-dimension (2D) or 3-dimension (3D) graphic in MPEG-4, which pursues a new method of encoding an image signal based on the contents of an image by excluding block-based transform coding methods used in H.261, Joint Photographic Experts Group (JPEG), MPEG-1, and MPEG-2, and aims to implement high compression at an ultra-low speed of a 64-Kbps class while MPEG-1 and MPEG-2 focus at fast transmission by increasing a compression ratio.

MPEG-4 is object-oriented, meaning that MPEG-4 deals with objects, such as audio, video, an image, and text, as independent elements and combines the objects by means of a link, allowing a user to freely configure scenes or sounds. For example, if a sender splits an image, text, and the like in a scene as objects and transmits them separately, a receiver receiving information can combine the split objects into a single scene and allow a user to view the combined scene.

As described above, since MPEG-4 has an advantage of freely constructing content using separate objects, users can easily add new objects, such as new scenes or subtitles, to content possessed by them.

If reconstructed content is modified by several users, objects may overlap despite the intentions of an author. For example, when an author adds English subtitles on the bottom of the content in which a movie is recorded, and if a user adds Korean subtitles overlapping the English subtitles, the English subtitles are not displayed on a screen despite the intentions of the author.

As another example, when a broadcast station desires to transmit spot news while broadcasting broadcast content in which text or images are Computer Graphics (CG)-processed, the broadcast station adds text or an image representing the spot news to the broadcast content. That is, newly transmitted information, such as spot news, can overlap CG of broadcast content.

As described above, according to a conventional content display method, when a new object is added to content, objects of the content may be reproduced in an overlap state despite the intentions of the author. Thus, in order to prevent the undesired overlapping, a user must directly check whether the objects overlap, and if the objects overlap, the user must add the new object in a non-overlapping position.

### SUMMARY OF THE INVENTION

The present invention provides a method and apparatus for displaying content, whereby the content is displayed so as to prevent objects of the content from overlapping.

According to an aspect of the present invention, there is provided a method of displaying content, the method comprising: receiving changed scene information if scene information containing position information indicating the time at which objects constituting the content are displayed and positions of the objects to be displayed is changed; receiving objects for constituting the content based on the changed scene information and determining whether objects overlapping each other exist among the received objects; and displaying the content after selectively changing positions of the objects according to the determination result.

The receiving of the objects may comprise receiving object information containing types of the objects for constituting the content, the determining may comprise receiving the objects based on the object information, and the displaying may comprise displaying the content after selectively changing positions of the objects based on the object information and the scene information.

The scene information may further comprise important region information indicating a region as an important region containing an object that is desired not to be overlapped from among the objects of the content, and the determining may comprise determining based on the important region information whether an object overlapping the important region exists.

The displaying may comprise if it is determined that an object overlapping the important region exists, displaying the content after changing a position of the object overlapping the important region to a position having the minimum moving distance from the important region and non-overlapping the important region.

The displaying may comprise if an object overlapping the important region exists, and if there are a plurality of important regions, displaying the content after changing a position of the object overlapping the important region to a position having the maximum moving distance from the important regions and non-overlapping the important regions.

The displaying may comprise if no object overlapping the important region exists, displaying the content without changing any position of the objects.

The object information may further comprise at least one of information on the number of objects and information on a network delivering the objects.

Each of the types of the objects may be audio, video, image, or text.

The object information, the scene information, and the objects may be received via a network.

The object information, the scene information, and the objects may be received from a storage unit storing them.

According to another aspect of the present invention, there is provided an apparatus for displaying content, the apparatus comprising: a receiver which receives changed scene information if scene information containing position information indicating the time at which objects constituting the content are displayed and positions of the objects to be displayed is changed; an overlap determiner which receives objects for constituting the content based on the changed scene information and determines whether objects overlapping each other exist among the received objects; and a display unit which displays the content after selectively changing positions of the objects according to the determination result.

The apparatus may further comprise a storage unit storing the object information, the scene information, and the objects.

According to another aspect of the present invention, there is provided a computer readable recording medium storing a computer readable program for executing a method of displaying content, the method comprising: receiving changed scene information if scene information containing position information indicating the time at which objects constituting the content are displayed and positions of the objects to be displayed is changed; receiving objects for constituting the content based on the changed scene information and determining whether objects overlapping each other exist among the received objects; and displaying the content after selectively changing positions of the objects according to the determination result.

### BRIEF DESCRIPTION OF THE DRAWINGS

The above and other features of the present invention will become more apparent by describing in detail exemplary embodiments thereof with reference to the attached drawings in which:

FIG. 1 is a block diagram illustrating a content display apparatus according to an exemplary embodiment of the present invention;

FIG. 2 illustrates a content configuration before a new object is added, according to an exemplary embodiment of the present invention;

FIG. 3 illustrates an operation of a display unit according to an exemplary embodiment of the present invention;

FIG. 4 illustrates an operation of a display unit according to another exemplary embodiment of the present invention; and

FIG. 5 is a flowchart illustrating a content display method according to an exemplary embodiment of the present invention.

### DETAILED DESCRIPTION OF THE INVENTION

Hereinafter, exemplary embodiments of the present invention will be described in detail with reference to the attached drawings.

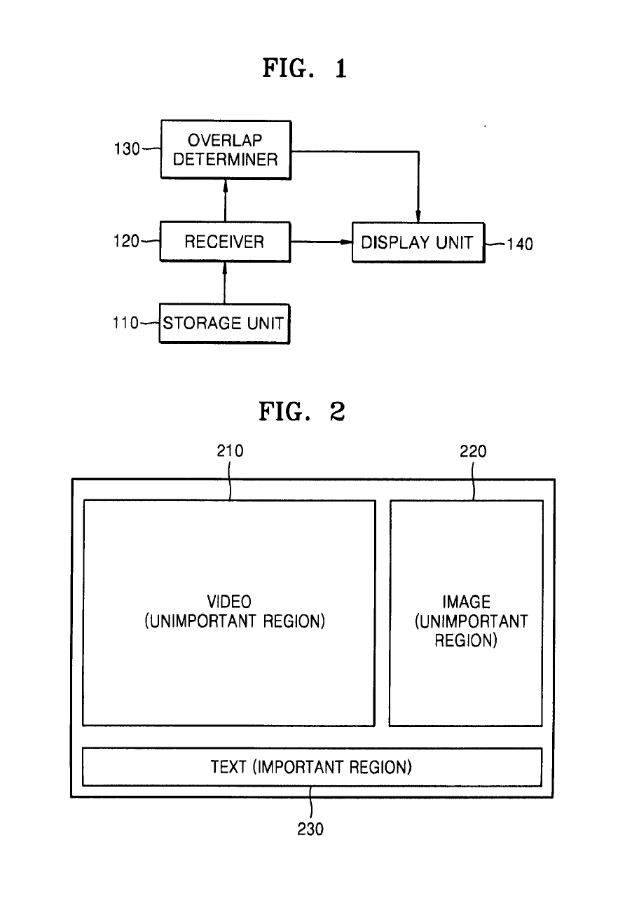

FIG. 1 is a block diagram illustrating a content display apparatus according to an exemplary embodiment of the present invention.

Referring to FIG. 1, the content display apparatus includes a storage unit 110, a receiver 120, an overlap determiner 130, and a display unit 140.

The receiver 120 receives object information containing types of objects for constituting content and scene information containing position information indicating the time at which objects constituting the content are displayed and positions of the objects to be displayed.

The object information contains all information related to the objects, such as the types of the objects, the number of objects, a compression format of the objects, and a data rate of a network delivering the objects. The types of the objects may be audio, video, image, and text.

For example, when movie content is reproduced, a moving picture to be displayed on a screen, subtitles, background music, and voice are required. In this case, each of the moving picture, the subtitles, the background music, and the voice is an object. Furthermore, the object information contains information specifying that a video type object, two audio type objects, and a text type object will be transmitted, for example. In addition, in the case of video, the object information may include information on whether the video was compressed using MPEG or H.264 and information on a data rate at which each object is transmitted via a network.

The scene information includes information on when and at which position the objects are displayed and information for setting the size of a region in which each object is displayed.

For example, if subtitles obtained by translating speech of characters are added to movie content, information that text occupying a region corresponding to 1/10 of a full screen for 3 seconds after 10 minutes and 10 seconds from the beginning is displayed becomes the scene information. In addition, the scene information further includes important region information indicating a region as an important region containing an object that is desired not to be overlapped from among the objects of the content. The region set as an important region is protected from being overlapped with other objects.

After the object information and the scene information are received, the receiver 120 receives objects required to constitute the content based on the object information and the scene information.

That is, the content is displayed by receiving the objects to constitute the content based on the object information and displaying the received objects at determined positions at a determined time based on the scene information.

However, if an event occurs, the receiver 120 receives new object information and new scene information. For example, the event may be to move a position of an object, delete an object, or add a new image or moving picture. If an event occurs, only the scene information or both the scene information and the object information may be changed.

For example, when an event, such as position movement or deletion of an object existing in the content, occurs, only the scene information is changed. On the other hand, when an event, such as addition of a new image or moving picture, occurs, both the scene information and the object information are changed.

The receiver 120 may receive the object information, the scene information, and the objects constituting the content from a network or the storage unit 110.

For example, when a broadcast station transmits spot news while broadcasting broadcast content, object information, scene information, and objects are received via a network. However, if a user wants to add subtitles occupied by the user to the broadcast content received via the network, the receiver 120 constructs the content by receiving the subtitles from the storage unit 110, and thus, the object, i.e., the subtitles, is received from the storage unit 110.

The overlap determiner 130 determines based on the received scene information whether objects overlapping each other exist among the received objects. If it is determined that objects overlapping each other exist, the overlap determiner 130 determines whether objects overlapping the important region exist among the overlapping objects.

The display unit 140 constructs content using objects received based on the object information and the scene information received by the receiver 120 and displays the content.

If the object information, the scene information, and the objects are received in an encoded state, the display unit 140 decodes the object information, the scene information, and the objects and constructs the content.

The display unit 140 selectively changes positions of objects according to a determination result of the overlap determiner 130 and displays the content.

That is, if no overlapping object exists, or even if an overlapping object does exist, if the overlapping object does not overlap the important region, the display unit 140 displays the content without changing positions of the objects. Alternatively, if an object overlapping the important region does exist, the display unit 140 changes a position of the object in the content and displays the content.

FIG. 2 illustrates a content configuration before a new object is added, according to an exemplary embodiment of the present invention.

Referring to FIG. 2, content according to the current embodiment includes an important region (referred to as 230) and unimportant regions (referred to as 210 and 220). That is, since regions containing video 210 and an image 220 are the unimportant regions, a user does not care whether another object is added and overlaps the video 210 or image 220 regions. However, since a region containing text 230 is located is the important region, another object must not overlap the text 230.

For example, in a case where the text 230 is English subtitles, if the user adds Korean subtitles in the region in which the text 230 is located, the Korean subtitles overlap the English subtitles, and thus, the Korean subtitles must be moved to another position.

However, an object located in an important region may be moved to another position and displayed instead of an added object upon implementation by a user.

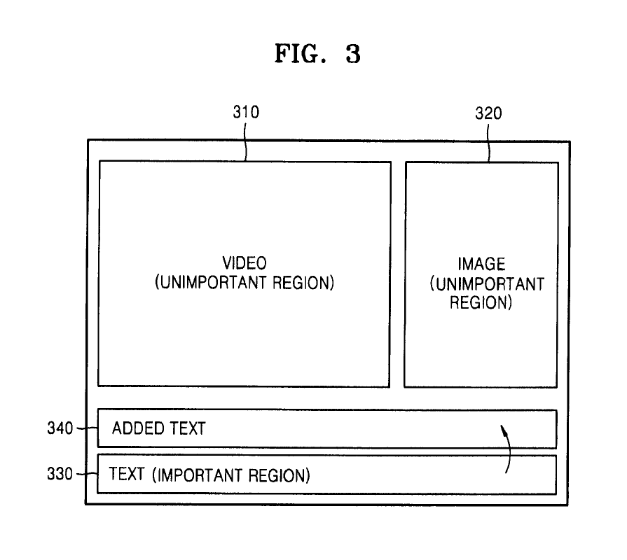

FIG. 3 illustrates an operation of the display unit 140 illustrated in FIG. 1, according to an exemplary embodiment of the present invention.

FIG. 3 depicts a state where if newly added text 340 overlaps text 330 located in an important region, the newly added text 340 is moved to upward the text 330 and displayed. That is, when an object overlapping an important region exists, the display unit 140 moves the object overlapping the important region (e.g., newly added text 140) to a position at which the object does not overlap the important region, wherein the moving distance is minimized.

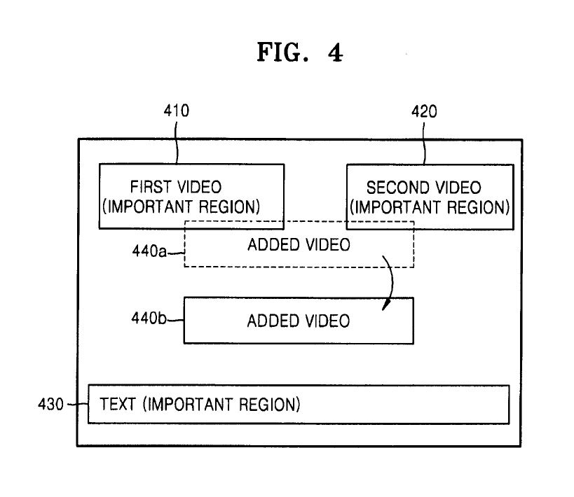

FIG. 4 illustrates an operation of the display unit 140 illustrated in FIG. 1, according to another exemplary embodiment of the present invention.

FIG. 4 depicts a state where if a moving picture 440a added to content including three important regions (referred to as 410, 420, and 430) overlaps first video 410 and second video 420 located in the important regions, the added video 440a is moved to another position. In this case, the video 440a moved to another position is moved to a position having the maximum distance from each of the first video 410, the second video 420, and text 430.

However, a method of moving an overlapping object and displaying content is not limited to the illustrations of FIGS. 3 and 4, and various methods can be used according to implementation.

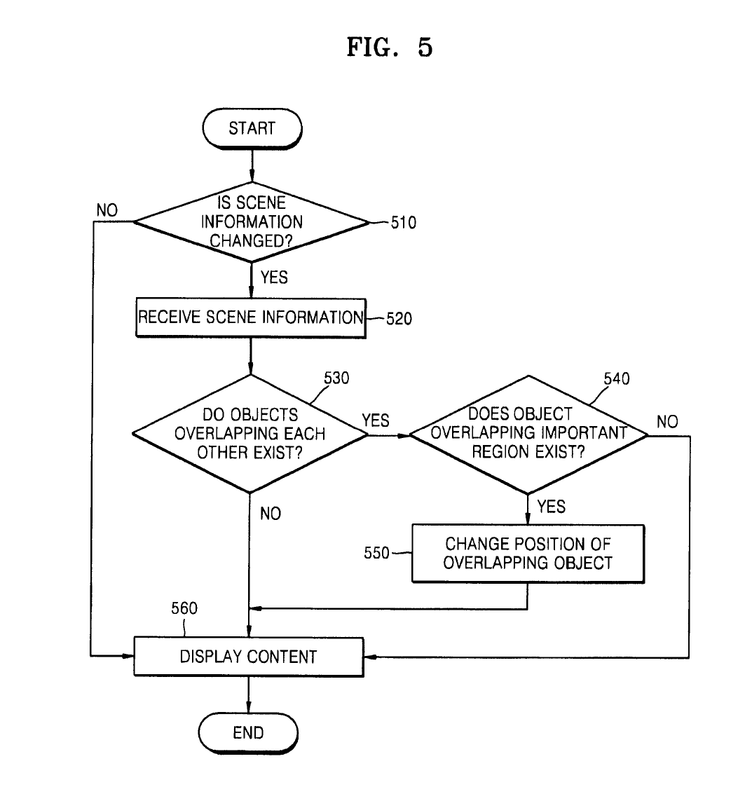

FIG. 5 is a flowchart illustrating a content display method according to an exemplary embodiment of the present invention.

It is determined in operation 510 whether scene information is changed. If it is determined in operation 510 that the scene information is not changed, content is constructed based on previously received scene information and displayed.

If it is determined in operation 510 that the scene information is changed, the changed scene information is received in operation 520. As described above, if an event occurs, the scene information is changed.

In operation 530, objects for constituting content are received based on the received scene information, and it is determined whether objects overlapping each other exist among the received objects.

If it is determined in operation 530 that objects overlapping each other exist, it is determined in operation 540 whether an object overlapping an important region exists.

If it is determined in operation 540 that an object overlapping an important region exists, a position of the overlapping object is changed in operation 550.

If it is determined in operation 530 that objects overlapping each other do not exist, or if it is determined in operation 540 that no object overlapping an important region exists, the content is displayed in operation 560 without changing positions of the objects. However, if it is determined in operation 540 that an object overlapping an important region exists, the content is displayed in operation 560 after changing the position of the overlapping object in operation 550.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

As described above, according to the present invention, in a content display method, when scene information is changed, it is determined based on the changed scene information whether objects overlapping each other exist among received objects, positions of the objects are selectively changed according to the determination result, and content is displayed. Thus, the content can be displayed without objects overlapping each other.

While this invention has been particularly shown and described with reference to preferred embodiments thereof, it will be understood by those skilled in the art that various changes in form and detail may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of displaying content, the method comprising:
receiving changed scene information if scene information containing position information indicating a time at which objects constituting the content are displayed and positions of the objects to be displayed is changed;
receiving objects for constituting the content based on the changed scene information and determining whether objects overlapping each other exist among the received objects; and
displaying the content after selectively changing positions of the objects according to the determination result.

2. The method of claim 1, wherein the receiving of the objects comprises receiving object information containing types of the objects for constituting the content,
the determining comprises receiving the objects based on the object information, and
the displaying comprises displaying the content after selectively changing positions of the objects based on the object information and the scene information.

3. The method of claim 1, wherein the scene information further comprises important region information indicating a region as an important region containing an object that is desired not to be overlapped from among the objects of the content, and
the determining comprises determining based on the important region information whether an object overlapping the important region exists.

4. The method of claim 3, wherein the displaying comprises if it is determined that an object overlapping the important region exists, displaying the content after changing a position of the object overlapping the important region to a position having a minimum moving distance from the important region without overlapping the important region.

5. The method of claim 3, wherein the displaying comprises if an object overlapping the important region exists, and if there are a plurality of important regions, displaying the content after changing a position of the object overlapping the important region to a position having a maximum moving distance from each of the plurality of important regions without overlapping the important regions.

6. The method of claim 3, wherein the displaying comprises if no object overlapping the important region exists, displaying the content without changing any position of the objects.

7. The method of claim 2, wherein the object information further comprises at least one of information on a number of objects and information on a network delivering the objects.

8. The method of claim 2, wherein each of the types of the objects is at least one of audio, video, image, and text.

9. The method of claim 2, wherein the object information, the scene information, and the objects are received via a network.

10. The method of claim 2, wherein the object information, the scene information, and the objects are received from a storage unit storing them.

11. An apparatus for displaying content, the apparatus comprising:
a receiver which receives changed scene information if scene information containing position information indicating the time at which objects constituting the content are displayed and positions of the objects to be displayed is changed;
an overlap determiner which receives objects for constituting the content based on the changed scene information and determines whether objects overlapping each other exist among the received objects; and
a display unit which displays the content after selectively changing positions of the objects according to the determination result.

12. The apparatus of claim 11, wherein the receiver further receives object information containing types of the objects for constituting the content, and the display unit displays the content after selectively changing positions of the objects based on the object information and the scene information.

13. The apparatus of claim 11, wherein the scene information further comprises important region information indicating a region as an important region containing an object that is desired not to be overlapped from among the objects of the content, and
the overlap determiner determines based on the important region information whether an object overlapping the important region exists.

14. The apparatus of claim 13, wherein if it is determined that an object overlapping the important region exists, the display unit displays the content after changing a position of the object overlapping the important region to a position having a minimum moving distance from the important region without overlapping the important region.

15. The apparatus of claim 13, wherein if an object overlapping the important region exists, and if there are a plurality of important regions, the display unit displays the content after changing a position of the object overlapping the important region to a position having a maximum moving distance from each of the plurality of important regions without overlapping the important regions.

16. The apparatus of claim 13, wherein if no object overlapping the important region exists, the display unit displays the content without changing any position of the objects.

17. The apparatus of claim 12, wherein the object information further comprises at least one of information on a number of objects and information on a network delivering the objects.

18. The apparatus of claim 12, wherein each of the types of the objects is at least one of audio, video, image, and text.

19. The apparatus of claim 12, wherein the object information, the scene information, and the objects are received via a network.

20. The apparatus of claim 12, further comprising a storage unit storing the object information, the scene information, and the objects.

21. A computer readable recording medium storing a computer readable program for executing the method of claim 1.
